(19) United States
(12) Patent Application Publication
(10) Pub. No.: US 2017/0011173 A1
(43) Pub. Date: Jan. 12, 2017

(54) MEDICAL DATA CARD SYSTEM

(71) Applicants: Dennis Retter, Fredeicksburg, VA (US); Brenda Sue Retter, Fredeicksburg, VA (US)

(72) Inventors: Dennis Retter, Fredeicksburg, VA (US); Brenda Sue Retter, Fredeicksburg, VA (US)

(21) Appl. No.: 14/796,130

(22) Filed: Jul. 10, 2015

(51) Int. Cl. G06F 19/00; G06K 19/08; G06K 7/00

(52) U.S. Cl. CPC G06F 19/323; G06K 7/0004; G06K 19/08

(57) ABSTRACT

A system for maintaining and updating patient data that includes: a magnetic card reader; a magnetic card; a memory chip on the magnetic card, where the memory chip stores patient data; and a biometric reader attached to the magnetic card reader. Preferably, the card reader updates patient data stored in the memory chip when the magnetic card is swiped through the magnetic card reader. The card reader may also enable a monetary transaction when the magnetic card is swiped through the magnetic card reader. In one additional feature, the patient data is stored on a remote database, where the patient data on the remote database is updated when the magnetic card is swiped through the magnetic card reader.

### BACKGROUND OF THE INVENTION

Field of Invention

The present invention relates to an encoded medical information card with patient data and networked card reader

Description of Related Art

Various types of encoded medical information systems and devices are known in the prior art. However, what is needed is an encoded medical information card with patient data and networked card reader that includes a card devised for patient prompt data to be written thereto, said patient prompt data thereby enabling assignment of any medical or monetary transaction effected with said card to update a particular patient record storable upon a database accessible by network when said card is used to travel through a networked card reader, wherein said patient record data is expeditiously updatable at a point of sale at time of transaction, or at a medical institution when procuring medical goods and/or services, whereby a patient's medical history and insurance information is accessible and updatable continuously by use of said card, and funds may be transacted from a specific linked account when said card is used, such as a Health Savings Account, for example, for payment for said medical goods and/or services.

### SUMMARY OF THE INVENTION

The present encoded medical information card with patient data and networked card reader enables access to a patient medical record, patient insurance information, and medical history by use of a card in conjunction with a networked card reader. Travel of the card through the card reader enables automatic update of patient record data to reflect a medical transaction. Financial transactions are also enabled concurrently when a monetary transaction is processed using the card, whereby funds may be transferred from linked or specific bank accounts (such as, for example, a Health Savings Account).

Use of the present encoded medical information card with patient data and networked card reader, therefore, maintains a patient medical record updatable by action of the card at a point of sale or at an office of a medical institution whenever a medical transaction or monetary transaction is processed when using the card, whereby patient record data storable upon a database remotely networked to the card reader is thereby expediently accessible and instantaneously updatable by action of said card.

The present encoded medical information card with patient data and networked card reader, therefore, includes a card having a high coercivity magnetic stripe thereupon, or other storage means whereby patient prompt data is storable (for example, a microchip embedded in the card). Patient prompt data writable to the card, therefore, prompts update and access to patient record data retrievable from a database remotely accessible by network from the networked card reader.

The term “patient record data”, or just “record data”, is used herein to include all medical data corresponding to a particular patient, including insurance information, prescriptions filled, course of drugs administered, treatments undertaken, allergies, past illnesses, family illnesses, behavioral factors (such as smoking, alcohol usage, sexual orientation and activity, etc.) and other data indicative of a complete and relevant medical history pertinent to treatment by a medical professional. The term “prompt data, as used herein throughout, is taken to include identifying data written to the card by which record data is access and transactions are assigned to update said record data at point of sale or a medical institution or office wherein a treatment or examination is administered.

A user may, therefore, use the instant encoded medical information card with patient data and networked card reader procure medical goods and services while simultaneously updating patient record data to reflect purchase of medical goods, for example (such as, for example, drugs or treatment options) whereby a medical history is recordable at point of sale and, further, effect payment for said goods or services concurrently by debit or credit applicable to an account accessible by the patient prompt data written to the card.

Biometric data may be required from a user to authenticate access to the patient record data. In an example embodiment herein disclosed, biometric data is capturable by means of a fingerprint scanner disposed upon the card reader whereby scan and matching of a patient dermatoglyph are required for processing of a medical and/or monetary transaction by use of the card.

Patient record data is not showable at a point of sale only, but accessible to a computer running a software application administering communication protocol to access a database wherein patient record data is storable. Communication protocol is contemplated to be secure, and enacted by Secure Shell (“SSH”), Secure Sockets Layer (“SSL”), Transport Layer Security (“TLS”), or other secure communications protocol controlling communication between networked computing devices. Patient record data may be partitioned or compartmentalized, whereby access at a particular medical institution or for a particular medical treatment is restricted from access to other partitions or compartments containing patient record data. An example is use a dentist's office may restrict access to patient record data pertinent only to dentistry. Additional partitions between medical disciplines, treatments, and institutions is contemplated as part of this device.

The present encoded medical information card with patient data and networked card reader, therefore, enables centralized hosting of patient record data, and therefore access to patient medical history, in an updatable capacity controllable by use of a card written with patient prompt data, whereby assignment of the transaction to a particular patient is effective and update of the patient record data is concurrent a medical or monetary transaction, as the case may be.

Thus has been broadly outlined the more important features of the present encoded medical information card with patient data and networked card reader so that the detailed description thereof that follows may be better understood and in order that the present contribution to the art may be better appreciated.

For better understanding of the encoded medical information card with patient data and networked card reader, its operating advantages and specific objects attained by its use, refer to the accompanying drawings and description.

### BRIEF DESCRIPTION OF THE DRAWINGS

FIG. 1 depicts a front view of a magnetic card reader according to the present invention.

FIG. 2 is a rear view of a magnetic card reader according to the present invention.

FIG. 3 is a front view and a rear view of a card used with the magnetic card reader according to the present invention.

### DETAILED DESCRIPTION OF THE DRAWINGS

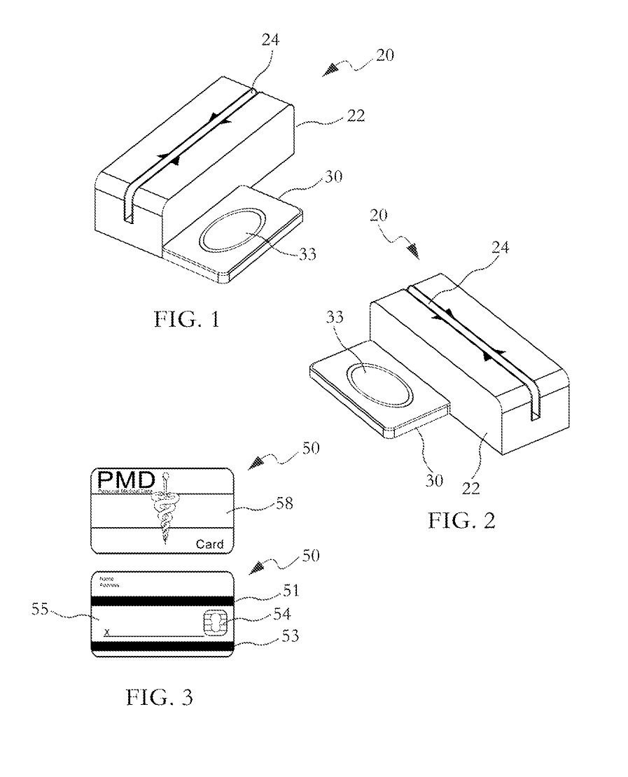

Referring to FIGS. 1 through 3 a preferred embodiment of the enclosed medical information card with patient data and networked card reader 20 is illustrated.

The present invention relates to an encoded medical information card 50 with patient data and networked card reader 10 to enable storage of medical data pertinent to a patient in an updatable and accessible capacity, wherein said patient's medical records may be updated at point of sale, when purchasing medication for example, visiting a doctor or dentist, or whenever a medical transaction occurs whereby a card 50 maybe swiped through a networked card reader 20.

Information encoded onto the card 50 is readable to update patient data that a particular medical transaction has occurred. For example, acquisition of certain medicine may be reflected in the updated patient data.

Patient data includes prompt data and record data. Prompt data is storable upon the card 50. Record data is stored on a database within a network linked with the card reader 20. Thus, when the card 50 is swiped through the networked card reader 20, the prompt data is readable and the record data is updatable according to the medical transaction taking place. The patient record data may be updated with each swipe of the card 50 through the card reader 20.

If is further contemplated that the card 50 may be effective for monetary transactions processed concurrent with medical transactions. By the term “medical transactions” is meant any transaction between the patient and a medical institution whereby medical services or goods are offered. The term “monetary transaction” includes any transaction between a patient and an institution where goods or services are procured by monetary exchange. Medical transactions thus involve medical data. Monetary transactions thus involve financial data.

It is contemplated that some medical transactions will also be monetary transactions. Monetary transactions may be processed as credit transactions, whereby a monthly balance is payable by the patient in arrears, or as debit transactions, whereby use of the card 50 to effect payment debits a monetary amount directly from a linked account held at a financial institution, such as, for example, a Health Savings Account.

Tax reporting is thus readily available as all monetary transactions that are also medical transactions are recordable in the patient's record data and the monetary expenditures documented as debits from the linked account or, where credit payments are made, from the statements issued for the payment.

To protect a patient's medical data, biometric identity verification may be required concurrent use of the card 50. In FIGS. 1 and 2, an exemplary embodiment of the networked card reader 20 as presented herein illustrates use of a fingerprint scanner 30, whereby prompt data on the card 50 is accessible to update a patient's record data only subsequent verification of the patient's identity by use of the fingerprint scanner 30. Sensitive and private medical record data, therefore, is protectable and access by unauthorized individuals is thereby preventable.

The present encoded medical information card with patient data and networked card reader 10, therefore, enables a centralized means of handling, processing, updating and accessing patient medical history and medical data. Patient record data includes a history of every medical transaction acceded by the patient. Medical professionals, therefore, may access a patient's record data and determine prescriptions, operations, treatments, and other medical data when determining treatment and procedural options, relative an established history storable as patient record data.

Moreover, medical practitioners unfamiliar with a patient may rapidly retrieve a patient's medical history to perform emergency action or other treatment. All allergies, drug aversions, and additional information are rapidly ascertainable, whereby effective and efficient treatment options can be expeditiously considered.

The present encoded medical information card 50 with patient data and networked card reader 10, therefore, enables efficient, centralized processing of medical transactions to update a patient's record data while effecting any payment for receipt of said medical transactions in an expeditious, convenient, and timely capacity.

In the exemplary embodiment illustrated herewith, the card 50 includes a high coercivity magnetic stripe 52 and microchip 54, which promptly stores encoded data. A card 50 may, therefore, be written to a particular patient. Patient data is storable with the patient's record data in a database accessible by the card 50 and through an authorized back-channel, whereby new cards 50 may be issued, as needed.

The card reader 20 includes a base unit 22 having a card reader channel 24 disposed therein, whereby movement of the card 50 through the channel 24 with the magnetic stripe 52 in contact therewith effects reading of the data related to the medical transaction and update the patient record data. Monetary transactions are likewise processed, with the debit or credit thereby made to the correct patient account.

A fingerprint scanner 30 is disposed upon the base unit 20. The fingerprint scanner 30 activates a data access to the patient record data only when biometric data collected from the patient (i.e. by scanning, and recognizing a dermatoglyph of the patient placed in contact with the scanner). If the dermatoglyph is not a match, record data is not accessible or updatable, and the medical (and monetary) transaction is denied.

View of a patient's record data is enabled at medical institutions such as hospitals, doctor's offices, dentist's offices, upon a computer accessible to the database, and may be effective partitioned between medical fields. For example, a patient visiting a dentist may present the card 50 for scanning to pay for a crown, say, and the dentist office may have access only to dental information on the card—said prompt data interfacing with the card reader 20 at the dentist's office whereby a code thereon enables access restricted to a partition of the patient record data, in this example, “dental data”.

It should be further recognized that purchase of drugs at a pharmacy, say, will effect medical record data remotely, without a pharmacist or store clerk actually seeing the patient record data. Such a transaction is processed as a monetary transaction at the point of sale, and only information pertinent to the purchase at hand is accessible at the point of sale. The medical transaction occurs remotely at the database wherein the patient record data is stored.

The present encoded medical information card with pertinent data and networked card reader, therefore, enables restricted access to confidential patient record data and patient medical history, enables update of said record data at time of a medical transaction, and is usable concurrent said medical transaction to effect payment therefore by processing a monetary transaction simultaneously. The instant invention has been shown and described in what it considers to be the most practical and preferred embodiments. It is recognized, however, that departures may be made there from within the scope of the invention and that obvious modifications will occur to a person skilled in the art.

1. A system for maintaining and updating patient data comprising:
a. a magnetic card reader;
b. a magnetic card;
c. a memory chip on the magnetic card, where the memory chip stores patient data; and
d. a biometric reader attached to the magnetic card reader.

2. The system for maintaining and updating patient data according to claim 1, where the card reader updates patient data stored in the memory chip when the magnetic card is swiped through the magnetic card reader.

3. The system for maintaining and updating patient data according to claim 2, where the card reader also enables a monetary transaction when the magnetic card is swiped through the magnetic card reader.

4. The system for maintaining and updating patient data according to claim 1, where the patient data is stored on a remote database.

5. The system for maintaining and updating patient data according to claim 4, where the patient data on the remote database is updated when the magnetic card is swiped through the magnetic card reader.

6. The system for maintaining and updating patient data according to claim 1, where the magnetic card includes a high coercivity magnetic strip.

7. The system for maintaining and updating patient data according to claim 1, where the patient data includes insurance information, prescriptions filled, course of drugs administered, treatments undertaken, allergies, past illnesses, family illnesses, behavioral factors including smoking, alcohol usage, sexual orientation and activity, and other data indicative of a complete and relevant medical history pertinent to treatment by a medical professional.

8. The system for maintaining and updating patient data according to claim 1, further including a means to print a medical history from the patient data stored on the magnetic card.

9. The system for maintaining and updating patient data according to claim 3, where the biometric reader is a fingerprint scanner, where the card reader scans and matches a patient dermatoglyph to confirm processing of patient data and any monetary transaction.

10. The system for maintaining and updating patient data according to claim 2, where the patient data is compartmentalized based upon the medical services or goods rendered.
